(19) United States
(12) Patent Application Publication
(10) Pub. No.: US 2010/0100866 A1
(43) Pub. Date: Apr. 22, 2010

(54) Intelligent Shared Virtual Whiteboard For Use With Representational Modeling Languages

(75) Inventors: Robert J. Kamper, Round Rock, TX (US); Susan J. Smith, Richmond Hill (CA)

Correspondence Address: Weitzman Law Offices LLC, 425 Eagle Rock Avenue, Suite 102, Roseland, NJ, 07068, US

(73) Assignee: INTERNATIONAL BUSINESS MACHINES CORPORATION, Armonk, NY (US)

(21) Appl. No.: 12/255,254

(22) Filed: Oct. 21, 2008

(51) Int. Cl. G06F 9/44

(52) U.S. Cl. 717/105

(57) ABSTRACT

A computer implemented method for enabling an intelligent shared virtual whiteboard on an interconnected network of computers. An intelligent shared virtual whiteboard is hosted on a host computer. A user input is received from a remote client over a computer network. A representation of the user input is selected within a modeling language. The selected representation of the user input is stored on the host computer. The selected representation of the user input is displayed to all remote users of the intelligent shared virtual whiteboard.

### BACKGROUND

1. Field of the Invention

This disclosure relates generally to electronic whiteboards, and, more particularly, to an intelligent shared virtual whiteboard for use with representational modeling languages.

2. Description of Related Art

A whiteboard is traditionally a wall mounted glossy surface upon which non-permanent markings can be made using special dye-based markers. They are a common fixture in professional environments because of their utility for collective planning and exploratory design. The advent of the personal computer has moved the whiteboard into virtual space. Virtual whiteboards implemented using computer software allow users the same benefits as a physical whiteboard, while also providing higher types of functionality only implementable on a computer system.

It is desirable to implement an intelligent shared virtual whiteboard for use with representational modeling languages to allow remote, collaborative use of a virtual whiteboard among remote users.

### BRIEF SUMMARY

In one aspect of this disclosure, a computer implemented method for enabling an intelligent shared virtual whiteboard on interconnected network of computers is disclosed. An intelligent shared virtual whiteboard is hosted on a host computer. A user input is received from a remote client over a computer network. A representation of the user input is selected within a modeling language. The selected representation of the user input is stored on the host computer. The selected representation of the user input is displayed to all remote users of the intelligent shared virtual whiteboard.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWING

This disclosure is further described in the detailed description that follows, with reference to the drawings, in which:

FIG. 1 is a high level representation of an intelligent shared virtual whiteboard software running on two exemplary computer systems; and

FIG. 2 is a flow diagram illustrating a preferred sequence of steps for implementing an intelligent shared virtual whiteboard for use with representational modeling languages.

### DETAILED DESCRIPTION

This application discloses a method for implementing an intelligent shared virtual whiteboard for use with a representational modeling language. The disclosed embodiment retains the flexibility of a physical whiteboard while incorporating the advantages of computer implementation and remote accessibility through a computer network.

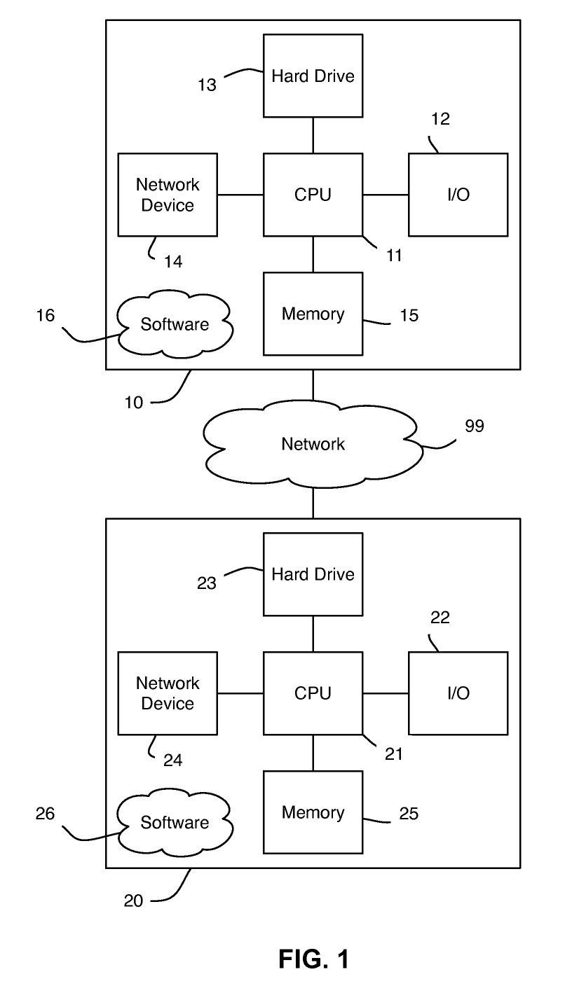

Referring to FIG. 1, an exemplary computer system 10 may utilize typical computer components, including central processing unit (CPU) 11 for processing instructions and performing calculations. Computer system 10 may also include a memory device 13 (e.g., a hard drive) for long-term information storage, and memory device 15 (e.g., random access memory (RAM)) for temporary fast access storage. A user may operate the system using input/output (I/O) device 12, which represents components including (but not limited to) a computer monitor, mouse, keyboard, and/or supplementary processors related to sound and video output. Computer system 10 may be connected to internet and/or intranet 99 through network device 14. Computer system 20 parallels computer system 10 with regard to components and manner of operation. A user may run intelligent shared virtual whiteboard host software 16 on computer system 10, and intelligent shared virtual whiteboard client software 26 on computer system 20. Computer 10 may be a host computer running the host copy of intelligent shared virtual whiteboard host software 16. Computer 20 may run a client copy of intelligent shared virtual whiteboard software 26. The illustrative virtual whiteboard may be rendered on computer 10 and accept inputs from both a remote user on computer 20 and a local user on computer 10

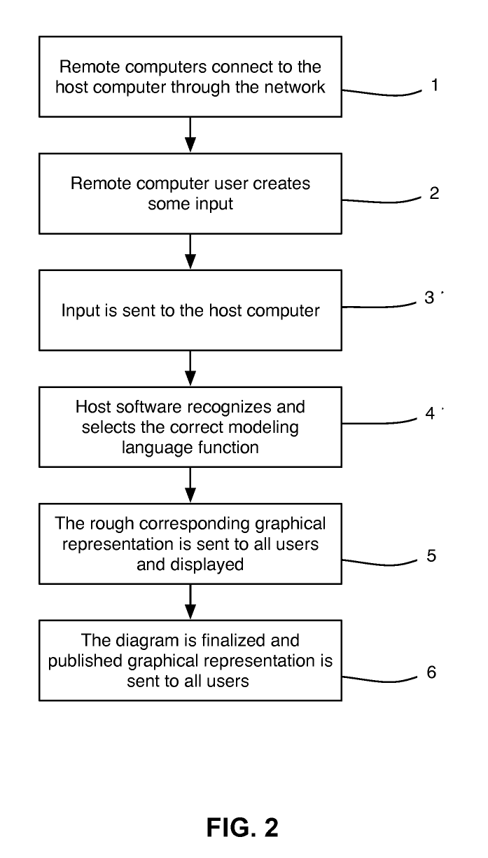

FIG. 2 is a flow chart illustrating a preferred sequence of steps for implementing an intelligent shared virtual whiteboard. In step 1, remote computer(s) 20 may connect to host computer 10 through network 99 using its respective network device 24. Network 99 is preferably a computer network, and may be, for example, the internet or an intranet. Implementation of a virtual whiteboard remotely accessible through the internet is desirable as it would allow remote users collaborative access to the virtual whiteboard from anywhere internet access is available. Intranet implementation facilitates collaboration on a project within a corporate intranet. The intelligent shared virtual whiteboard software 16 and 26 may preferably be used with either type of network.

The intelligent shared virtual whiteboard software 16 and 26 is preferably designed for use with at least one modeling language. In the preferred embodiment, whiteboard software 16 and 26 may be used with the Unified Modeling Language (UML). Other modeling languages, such as (but not limited to) Business Process Modeling Notation (BPMN), Extended Enterprise Modeling Language (EEML), Fundamental Modeling Concepts (FMC), Jackson Structured Programming (JSP) or Object Role Modeling (ORM) may be included in the functionality of the whiteboard software 16 and 26. In one embodiment, software 16 and 26 preferably allows a user to create a usage template within the software user interface for a previously unsupported modeling language, allowing for an infinite range of modeling languages. Ideally, these templates would be storable as individual files. Users would preferably be able to purchase, download or share modeling language templates created by other users.

In step 2, a remote user creates an input for the intelligent shared virtual whiteboard. The input is preferably communicated to the computer 20 using input/output device 22, which may include standard input methods, such as a mouse and keyboard. More advanced inputs may also be utilized, such as, for example, a mouse-pen, a stylus and tablet or even motion-tracking camera. The intelligent shared virtual whiteboard software 16 and 26 preferably utilizes a wide variety of any single input device or combination of input devices as desired by the user, including (but not limited to) those described above.

In step 3, the user input is received by the intelligent shared virtual whiteboard client software 26, which preferably stores the input in memory 25 for processing and then instructs CPU 21 to transmit the input through network device 24 to network 99. Host computer 10 receives the input through network device 14 and preferably stores it for processing in fast access memory 15. Intelligent shared virtual whiteboard host software 16 executing on host computer 10 receives the user input. In the preferred embodiment, access control is preferably implemented to allow a moderator user or the system itself to control the access, amount and timing of user inputs. This preferably prevents the whiteboard from becoming chaotic with respect to user access and organization, as well as protecting the information on the whiteboard from harm caused by a malicious user.

In step 4, intelligent shared virtual whiteboard host software 16 recognizes the logical representation of the input within the selected modeling language being used. The information is then preferably stored programmatically. For example, in the preferred embodiment, the whiteboard software 16 recognizes a hand-drawn input via graphical recognition of geometric shapes. The whiteboard software 16 would preferably compare the hand-drawn shape to a set of geometric shapes appropriate to the modeling language being used and select the closest match. In another embodiment, a set of closest matches is returned to the user generating the input. The user would preferably then select the intended modeling language shape from a graphical menu on the user's display 22. In a yet another embodiment, the recognition process is performed by the client software 26 before user input information is transmitted to the host computer.

In the preferred embodiment, extensible markup language (XML) is used to programmatically store and conceptualize each modeling language object. In other embodiments, any code language that is appropriate to this purpose may be used.

In step 5, intelligent shared virtual whiteboard host software 16 preferably selects a “rough” graphical representation of the user input and renders the new state of the whiteboard by sending the relevant asset output through network device 14. A “rough” graphical representation is preferably used to foster a creative atmosphere where people are free to think “outside-the-box.” A “published” graphical representation is generated only upon finalization of modeling. The information preferably passes through network 99 and is received by remote user on computer 20 and then preferably displayed to the user using input/output device 22. In the preferred embodiment, input/output device 22 is a display monitor. When multiple users are active on a single intelligent shared virtual whiteboard, the information is preferably transmitted over network 99 to each remote user.

When the whiteboard is ready for finalization, a finalization option is preferably used to publish the final state of the whiteboard. In step 6, the intelligent shared virtual whiteboard is finalized. Host software 16 retrieves all modeling language object data on the current state of the whiteboard and converts each object from a “rough” graphical representation to a “published” graphical representation. The finalized intelligent shared virtual whiteboard is preferably transmitted to all remote users through network 99. The finalization option may be controlled from the host computer 10, by the system or by a remote user with delegated moderator authority. In a corporate environment, a project manager may be selected to moderate the digital whiteboard and therefore decide when finalization is appropriate. The actual activator is preferably a graphical button displayed on screen and interacted with using input/output device 12 or 22. For more dedicated computer systems, the activator may be a pre-defined button on the keyboard, mouse or some other gesture or indicator for the chosen input device.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

1. A computer implemented method for enabling an intelligent shared virtual whiteboard on an interconnected network of computers, comprising:
hosting an intelligent shared virtual whiteboard on a host computer;
receiving a user input from a remote client over a computer network, wherein the input is a hand-drawn shape;
comparing the input to a set of geometric shapes within a modeling language;
generating a closest match subset from the set of geometric shapes that corresponds to the closest match to the input and displaying the closest match subset of geometric shapes;
selecting a representation of the input from the closest match subset;
storing the selected representation of the user input on the host computer; and
displaying a rough graphical representation of the selected representation of the user input to all remote users of the intelligent shared virtual white board; and
displaying a published graphical representation of the selected representation of the user input to all remote users upon finalization and publication of the intelligent shared virtual whiteboard.
